(19) United States
(12) Patent Application Publication
(10) Pub. No.: US 2011/0025604 A1
(43) Pub. Date: Feb. 3, 2011

(54) System for adjusting a light output of an optical mouse and a mouse thereof

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,154

(22) Filed: Aug. 3, 2009

(51) Int. Cl. G06F 3/033

(52) U.S. Cl. 345/166

(57) ABSTRACT

A mouse includes a lighting unit, a sensing unit, and a control unit. The lighting unit is used for generating a light output to shine onto a contact surface. The sensing unit is connected with the lighting unit, and forms an image for generating an image signal from the reflection of the light upon the contact surface. The controller unit is connected with the sensing unit, and is for controlling the light output of the lighting unit according to a reference value. In addition to calculating the movement of the mouse according to the image signal, the control unit also directly outputs the image signal to an application system with an image analysis function. Therein, the application system is for analyzing the image signal and outputting a correcting value to the control unit; and the control unit is for adjusting the reference value according to the correcting value.

### BACKGROUND OF THE INVENTION

1. Field of the Invention

The present invention relates to a mouse; in particular, the present invention relates to an optical mouse, whose light output can be adjusted to match the reflectivity of the contact surface and a system for adjusting the light output of the mouse.

2. Description of Related Art

The resolution and the usage sensitivity of an optical mouse are highly affected by the material and the color of the contact surface. For an LED optical mouse or a laser optical mouse, whether or not the mouse has moved changes neither the brightness of its light output nor the interval at which the light source is switched on and off. Therefore, the sensitivity of the mouse is affected primarily by changes of the reflectivity of the contact surface.

When the light source of the optical mouse is weak, the optical mouse is best used on a bright colored contact surface. However, when the user uses the optical mouse on a dark colored contact surface and lifts the optical mouse a short distance from the contact surface, then the sensor in the mouse may fail to detect reflected light from the contact surface due to the light being inadequate. Therefore, the movement of the mouse is not detected, and the sensing operation of the sensor is eventually and subsequently turned off so as to conserve power.

When the light source of the optical mouse is very bright, the optical mouse is best used on a dark colored contact surface. However, when the user uses the optical mouse on a bright contact surface and lifts the optical mouse a distance from the contact surface, the sensor in the mouse may still receive the reflected light from the contact surface. This means that the mouse may erroneously detect a movement.

For the interval of the light source being on and off, the controller in the mouse controls the sensor to obtain the reflected light according to the interval between the light source being in the on and the off state. The movement of the mouse is calculated by referring to the obtained reflected light. When the reflectivity of the contact surface is not uniform, the accuracy of the movement is also affected even though the interval of the light source being on and off has not changed.

Therefore, the uniformity of the contact surface is a factor that may affect the operation of the optical mouse. The resolving of this problem and so as to make the optical mouse be suitable for a variety of contact surfaces is thereby an issue of concern for designers of optical mouse.

### SUMMARY OF THE INVENTION

One particular aspect of the present invention is to provide a mouse that can adjust the light output according to the reflectivity of the contact surface and a system for adjusting the light output of the mouse to solve the problem of the sensitivity caused by the reflectivity of the contact surface. The function of the mouse can be improved.

The mouse includes a lighting unit, a sensing unit, and a control unit. The lighting unit is used for generating a light output to shine onto the contact surface. The sensing unit is connected with the lighting unit, and forms an image to generate an image signal from the reflection caused by the light output shining onto the contact surface. The controller unit is connected with the sensing unit, and controls the light output of the lighting unit according to a reference value. In addition to calculate the movement of the mouse according to the image signal, the control unit also directly outputs the image signal to an application system with an image analysis function. The control unit receives a correcting value generated from the application system analyzing the image signal to adjust the reference value. The light output of the lighting unit is changed to match the reflectivity of the contact surface.

The system for adjusting the light output of the mouse includes a controlled mouse, and an adjusting module. The controlled mouse has a lighting unit. The controlled mouse controls the lighting unit to generate the light output according to a reference value, and forms an image to generate an image signal from the reflection caused by the light output shining onto the contact surface. The adjusting module is connected with the controlled mouse for receiving the image signal, and analyzing the image signal to output a correcting value to the controlled mouse. Thereby, the controlled mouse adjusts the reference value according to the correcting value to adjust the light output of the lighting unit.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a block diagram of the system for adjusting the light output of a mouse according to the present invention; and

FIG. 2 is a schematic diagram of an adjusting module according to the present invention.

### DETAILED DESCRIPTION OF THE PREFERRED EMBODIMENTS

The present invention adjusts the light output of the mouse so as to make the mouse be suitable for a variety of contact surfaces with different reflectivity. The mouse can be steadily operated. For overcoming the light output being absorbed by a dark color contact surface, the interval of the light output being on and off is reduced and the brightness of the light output is increased. For overcoming the halo of the shadow that is caused by strong reflection from a bright colored contact surface, the interval of the light output being on and off is increased and the brightness of the light output is reduced. The interval of the light output being on and off is controlled by a switch and a time value. The brightness of the light output of the mouse is controlled by adjusting the control current. The interval of the light output being on and off and the brightness of the light output can be adjusted at the same time, or one of the two may be adjusted according to the requirements. The following embodiment shows adjustment for both the interval of the light output being on and off and the brightness of the light output.

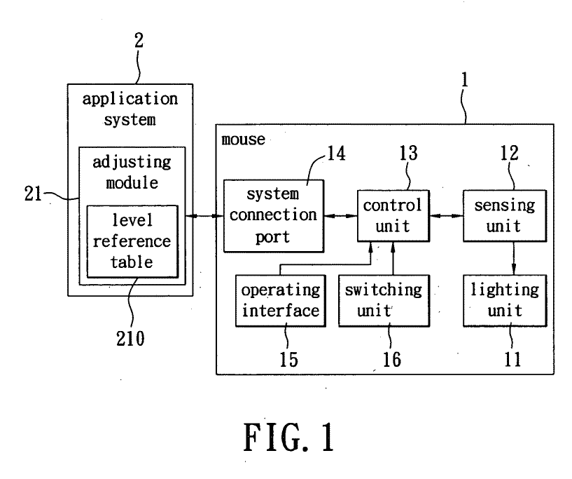

Reference is made to FIG. 1, which shows a block diagram of a system for adjusting the light output of a mouse according to the present invention. The system for adjusting the light output of the mouse includes a mouse 1 and an application system 2. The mouse 1 is operated on a contact surface (not shown in the figure) by a user. The application system 2 can be a computer.

In this embodiment, the optical mouse 1 includes a lighting unit 11, a sensing unit 12, a control unit 13, and a system connection port 14. The application system 2 has an adjusting module 21, and the adjusting module 21 has a level reference table 210 so that the application system 2 has an image analysis function. The level reference table 210 records the brightness default value and the contrast default value reflected by the light output of the lighting unit 11 with different currents.

For the mouse 1, the lighting unit 11 is used for generating light output to shine onto the contact surface. The lighting unit 11 can be designed as LED or laser diode, but the present invention is not limited thereby.

The sensing unit 12 is connected with the lighting unit 11 for forming an image signal from the reflection shadow caused by the light output shining on the contact surface. The sensing unit 12 is a complementary metal oxide semiconductor (CMOS) image sensor. Using a CMOS as the sensing unit 12 has a lot of merits, including small dimension, low power consumption, low price, and ease of integration, etc. When the requirements of light sensitivity and resolution are high, the sensing unit 12 can be a charge coupled devices (CCD) image sensor.

The control unit 13 is connected with the sensing unit 12, and controls the light output of the lighting unit 11 according to a reference value. The control unit 13 controls the light output of the lighting unit 1 1; specifically_ the control unit 13 respectively controls the interval of being on and off and the brightness of the lighting unit 11 according to a time reference value and a current reference value. In this embodiment, in addition to calculating the movement of the mouse according to the image signal provided by the sensing unit 12, the control unit 13 also directly outputs the image signal to an application system 2. When the control unit 13 calculates the movement, the control unit 13 calculates the moving distance and direction of the coordinate of the mouse according to the two image signals provided by the sensing unit 12. It is well known to those skilled in this field, and therefore is not illustrated in further detail.

Because the application system 2 is electrically connected with the mouse 1, the adjusting module 21 can communicate with the control unit 13. The adjusting module 21 receives the image signal transmitted from the control unit 13 and analyzes the image signal. After the image signal is analyzed, the adjusting module 21 outputs a correcting value to the control unit 13 so as to adjust or update the reference value. Specifically, the adjusting module 21 analyzes the intensity of the image signal, and contrasts the intensity with the value given in the level reference table 210 according to the setting current for generating a level difference value. Then, the level difference value is output to the control unit 13. In this embodiment, in addition to output the correcting value according to the level difference value, the adjusting module 21 can also provide the level difference value to the user and so that the user may determine the desired correcting value.

Thereby, the control unit 13 of the mouse 1 further uses the adjusted or updated reference value to change the interval and the output current, and thereby controls the interval of being on and off and the brightness of the lighting unit 11. By changing the light output of the lighting unit 11, the mouse 1 can be applied, to a variety of contact surfaces with different characteristics so that the user can steadily operate the mouse 1.

One end of the system connection port 14 of the mouse 1 is connected with the control unit 13, and another end is connected with the application system 2; thereby the system connection port 14 acts as a signal transmission channel between the control unit 13 and the application system 2. The system connection port 14 can be connected with the application system 2 in a wired or wireless way.

For supplementary explanations, the mouse 1 further comprises an operating interface 15 and a switching unit 16. The operating interface 15 has at least one button and a wheel, and is connected with the control unit 13. The switching unit 16 is connected with the control unit 13 for controlling the control unit 13 to operate in an operating mode or an adjusting mode.

In actual application, if the mouse 1 still can not be operated smooth in the contact surface when the control unit 13 has received the correcting value for adjusting and updating the reference value, the embodiment further provides another method for processing the adjustment. Users can operate the switching unit 16 for controlling the control unit 13 to operate in an adjusting mode, and then operate the operating interface 15 to generate a supplementary correcting vale to the control unit 13 for further adjusting the reference value directly.

On the other hand, if users want to use the mouse 1 normally, users just need to control the control unit 13 to operate in an operating mode through operating the switching unit 16. At this time, users can use the mouse 1 through operating the operating interface 15 to generate an operating signal such as a button signal, a wheel signal and so on.

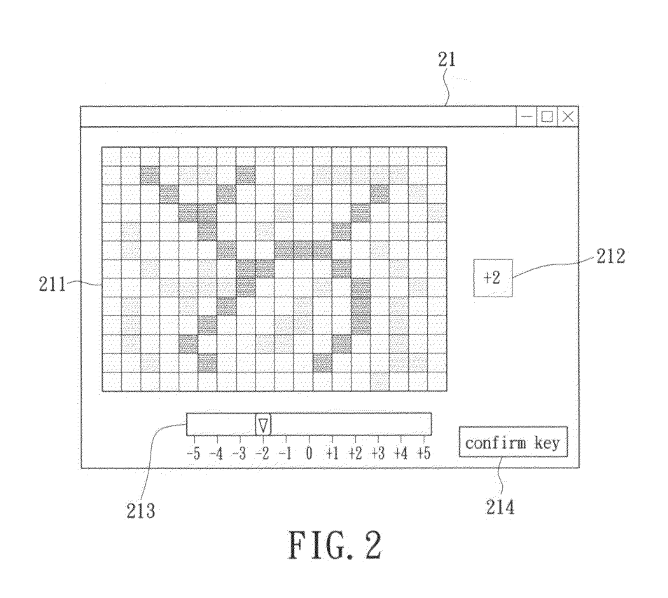

In order to illustrate the adjusting module 21 in detail, reference is made to FIG. 2 which is a schematic diagram of the adjusting module of the present invention. In this embodiment, a software application program is used for implementing the adjusting module 21. Alternatively, the adjusting module 21 can also be implemented by a hardware device. For cost consideration, a software application program is preferred.

As shown in FIG. 2, the adjusting module 21 includes an image display interface 211, a data display interface 212, a function of micro adjustment 213, and a confirm key 214. The image display interface 211 displays the image of the image signal according to the image signal transmitted by the control unit 13, so that the user may refer the obtained image of the sensing unit 12 of the mouse 1. The adjusting module 21 analyzes the image signal and generates the level difference value, wherein the data display interface 212 display the data of the level difference value. As shown in FIG. 2, the data display interface 212 displays the level difference value “+2”. That means that the intensity of the image signal generated by the sensing unit 12 under the current value is higher than the default value in the level reference table 210 by two levels. In other words, the mouse 1 is applied to the lighter color contact surface so that the lighting unit 11 generates a stronger reflection light under the current value.

The function of micro adjustment 213 is used for adjusting the level. As shown in FIG. 2, the function of micro adjustment 213 automatically generates the correcting value according to the level difference value displayed on the data display interface 212, such as the correcting value “−2”. Alternatively, the user can also adjust the correcting value according to the user's operation habit on the mouse. After the adjusting operation is finished, the user presses the confirm key 214 to transmit the correcting value indicated by the micro-adjusting interface 213 to the control unit 13 of the mouse 1. In this particular example, the control unit 13 then adjusts or updates the time reference value and the current reference value according to the correcting value so as to increase the time interval and reduce the output current. Thereby, the time interval of the lighting unit 11 being on and off is increased and the brightness of the lighting unit 11 is reduced to match the bright colored contact surface.

When the adjusting module 21-analyzes the image signal and the data display interface 212 displays a negative level difference value, it means that the mouse 1 is applied to the dark colored contact surface and the lighting unit 11 generates a darker reflection light under the current. For this example, the micro-adjusting interface 213 then generates a corresponding positive correcting value. Similarly, the user can also adjust the correcting value manually. Subsequently, user presses the confirm key 214 to confirm the desired output correcting value and transmit the correcting value to the control unit 13 of the mouse 1. The control unit 13 adjusts or updates the time reference value and the current reference value according to the correcting value, so as to decrease the time interval and increase the output current. Thereby, the time interval of the lighting unit 11 being on and off is reduced and the brightness of the lighting unit 11 is increased to match the dark colored contact surface.

As shown in FIG. 2, in addition to implementing the function of micro adjustment 213 by a scrollbar, the function of micro adjustment 213 also can be implemented by a selection menu (such as a pop down selection menu). The adjusting module 21 also has two functions of micro adjustments 213 respectively for adjusting the time interval of being on and off and the brightness of the lighting unit.

The control unit 13 for adjusting the time interval and the current according to the reference value can be implemented and changed according to the circuit of the mouse, and is not illustrated in the embodiment.

For the adjusting module 21, in addition to the design pattern as shown in FIG. 2, the adjusting module 21 also can be designed as a single display interface (not shown in the figure) for integrating the image display interface 211 and the data display interface 212 in FIG. 2 so that the display interface may directly displays the icon of the image signal and the level difference value in a stacked way according to the image signal and the level difference value.

Without increasing the hardware cost of the mouse, the light output of the mouse can be adjusted to match contact surfaces that have different brightness, so that the mouse can be normally operated regardless of the uniformity of the contact surface. When the user uses the mouse,.the user does not need to find a specific plane or mouse pad. The function of the mouse is thereby enhanced.

The description above only illustrates specific embodiments and examples of the present invention. The present invention should therefore cover various modifications and variations made to the herein-described structure and operations of the present invention, provided that they fall within the scope of the present invention as defined in the following appended claims.

What is claimed is:

1. A mouse, comprising:
a lighting unit for generating a light output to shine onto a contact surface;
a sensing unit that is connected with the lighting unit, and the sensing unit is for forming an image signal according to the reflection of the light; and
a control unit that is connected with the sensing unit, and the control unit is for controlling the light output of the lighting unit according to a reference value, wherein in addition to calculating the movement of the mouse according to the image signal, the control unit also directly outputs the image signal to an application system with an image analysis function;
wherein the application system is for analyzing the image signal and outputting a correcting value to the control unit, so that the control unit may adjust the reference value according to the correcting value; and thereby light output of the lighting unit may be changed for matching the brightness of the contact surface.

2. The mouse as claimed in claim 1, wherein the control unit controls the interval of the lighting unit so as to make the brightness of the contact surface be suitable for sensing unit to retrieve a clear image.

3. The mouse as claimed in claim 1, wherein the application system further comprises:
an adjusting module connected with the control unit for analyzing the image signal to output the correcting value.

4. The mouse as claimed in claim 3, wherein the adjusting module has a level reference table, and the adjusting module analyzes the intensity of the image signal and compares the intensity with the values given in the level reference table so as to generate a level difference value.

5. The mouse as claimed in claim 4, wherein the adjusting module further comprises:
an image display interface displaying an icon of the image signal according to the image signal;
a data display interface for displaying the data of the level difference value according to the level difference value.

6. The mouse as claimed in claim 4, wherein the adjusting module further comprises:
a display interface for displaying an icon of the image signal and the data of the level difference value respectively according to the image signal and the level difference value.

7. The mouse as claimed in claim 4, wherein the adjusting module further comprises:
a function of micro adjustment for generating the correcting value according to the level difference value.

8. The mouse as claimed in claim 7, wherein the function of micro adjustment is a scrollbar or a selection menu.

9. The mouse as claimed in claim 1, further comprising:
a system connection port for providing the connection between the control unit and the application system;
an operating interface that is connected with the control unit;
a switching unit that is connected with the control unit, and the switching unit is for controlling the control unit to operate in an operating mode or an adjusting mode;
wherein when the control unit is operated in the operating mode, the control unit receives an operating signal generated by the operating interface and outputs the operating signal to the application system; when the control unit is operated in the adjusting mode, the control unit receives a supplementary correcting value generated by the operating interface and further adjusts the reference value according to the supplementary correcting value.

10. The mouse as claimed in claim 9, wherein the connection via the system connection port can be in a wired or wireless way.

11. The mouse as claimed in claim 9, wherein the operating interface further comprises at least one button and a wheel.

12. The mouse as claimed in claim 1, wherein the lighting unit is a LED or a laser diode.

13. The mouse as claimed in claim 1, wherein the sensing unit is a CMOS image sensor or a CCD image sensor.

14. A system for adjusting a light output of an optical mouse, comprising:
a controlled mouse having a lighting unit, wherein the controlled mouse is for controlling the lighting unit so as to generate a light output according to a reference value, and for generating an image signal according to the reflection of the light upon a contact surface; and
an adjusting module that is connected with the controlled mouse for receiving the image signal, and the adjusting module is for analyzing the image signal and outputting a correcting value to the controlled mouse;
thereby, the controlled mouse adjusts the reference value according to the correcting value so as to adjust the light output of the lighting unit.

15. The system as claimed in claim 14, wherein the controlled mouse adjusts the reference value according to the correcting value in order to adjust the interval of the lighting unit being on and off and/or the brightness of the light output of the lighting unit.

16. The system as claimed in claim 15, wherein the adjusting module is located in an application system and has a level reference table, the adjusting module analyzes the intensity of the image signal and compares the intensity with the values given in the level reference table so as to generate a level difference value.

17. The system as claimed in claim 16, wherein the adjusting module further comprises:
an image display interface for displaying an icon of the image signal according to the image signal; and
a data display interface for r displaying data of the level difference value according to the level difference value.

18. The system as claimed in claim 16, wherein the adjusting module further comprises:
a display interface for displaying an icon of the image signal and the data of the level difference value respectively according to the image signal and the level difference value.

19. The system as claimed in claim 16, wherein the adjusting module further comprises:
a function of micro adjustment for generating the correcting value according to the level difference value.

20. The system as claimed in claim 19, wherein the function of micro adjustment is a scrollbar or a selection menu.
